(19) United States
(12) Patent Application Publication
(10) Pub. No.: US 2024/0142557 A1
(43) Pub. Date: May 2, 2024

(54) ANTENNA ORIENTATION DETECTION FOR INTERFERENCE DETECTION AND MITIGATION

(71) Applicant: QUALCOMM Incorporated, San Diego, CA (US)

(72) Inventors: Yuxiang PENG, Sunnyvale, CA (US); Liang ZHAO, Saratoga, CA (US); Ning LUO, Cupertino, CA (US)

(21) Appl. No.: 18/051,843

(22) Filed: Nov. 1, 2022

(51) Int. Cl. G01S 1/08; G01S 1/02

(52) U.S. Cl. CPC G01S 1/08; G01S 1/022

(57) ABSTRACT

The user equipment (UE) of an antenna orientation detection system may receive a first set of beacon signals via an antenna at the UE. Each of the first set of beacon signals may be associated with a corresponding indication of an expected beacon location. The UE may calculate an orientation of the antenna based on the first set of beacon signals. The UE may change at least one of a position, the orientation, or a direction of the antenna and receive a second set of beacon signals. The UE may calculate at least one of a set of interfering condition parameters, a set of spoofing condition parameters, or a set of non-line-of-sight (NLOS) condition parameters based on the first set of beacon signals and the second set of beacon signals.

### TECHNICAL FIELD

The present disclosure relates generally to communication systems, and more particularly, to a wireless device system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. It may be beneficial for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may receive a first set of beacon signals via an antenna at the UE. Each of the first set of beacon signals may be associated with a corresponding indication of an expected beacon location. The UE may calculate an orientation of the antenna based on the first set of beacon signals.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a wireless communications system including a plurality of interfering conditions, in accordance with various aspects of the present disclosure.

FIG. 6A is a diagram illustrating an example of a sky-plot generated from a receiver of a UE configured to communicate with a wireless system, in accordance with various aspects of the present disclosure.

FIG. 6B is a diagram illustrating an example of a sky-plot generated from another receiver of a UE configured to communicate with the wireless system of FIG. 6B, in accordance with various aspects of the present disclosure.

FIG. 7A is a diagram illustrating an example of a UE with a directional antenna configured to communicate with a wireless system, in accordance with various aspects of the present disclosure.

FIG. 7B is a diagram illustrating an example of the UE of FIG. 7A in a different configuration, in accordance with various aspects of the present disclosure.

FIG. 8 is a communications flow diagram of a UE, in accordance with various aspects of the present disclosure.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

### DETAILED DESCRIPTION

A user equipment (UE) may be configured to determine an orientation of an antenna by performing positioning, changing its location, and then by performing positioning again. However, such translational movement and repeating positioning measurements may waste both power and time. It may be beneficial for the UE to determine an orientation of its antenna during a static start, particularly if the UE is attached to, or is integrated with, a vehicle that uses a navigation system. Moreover, the UE may be configured to use positioning information to change the position, orientation, or direction of one or more of its antennas to prevent or minimize interference, for example interference with another wireless device, interference from a jamming device, interference from a spoofing device, or interference from a device that blocks wireless transmission. However, determining a location of such interfering devices may also utilize translational movements and repeated positioning methods that waste both power and time.

In some aspects, a UE may be configured to customize a directional antenna to estimate device orientation by analyzing beacon signals with corresponding location tags. In some aspects, the UE may be configured to customize a directional antenna to detect interference conditions (e.g., jamming, spoofing, non-line-of-sight (NLOS) conditions) by changing a position, orientation, or direction of an antenna, or by changing what antenna it uses. The UE may receive a first set of beacon signals via an antenna at the UE. Each of the first set of beacon signals is associated with a corresponding indication of an expected beacon location. The UE may calculate an orientation of the antenna based on the first set of beacon signals. The UE may calculate a forward-facing direction of an object based on the orientation of the antenna and an attachment configuration of the antenna relative to the object. The UE may change at least one of a position, the orientation, or a direction of the antenna. The UE may receive a second set of beacon signals after the at least one processor changes at least one of the position, the direction, or the orientation of the antenna. Each of the second set of beacon signals may be associated with the corresponding indication of the expected beacon location. The UE may calculate at least one of a set of interfering condition parameters, a set of spoofing condition parameters, or a set of non-line-of-sight (NLOS) condition parameters based on the first set of beacon signals and the second set of beacon signals.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media may include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

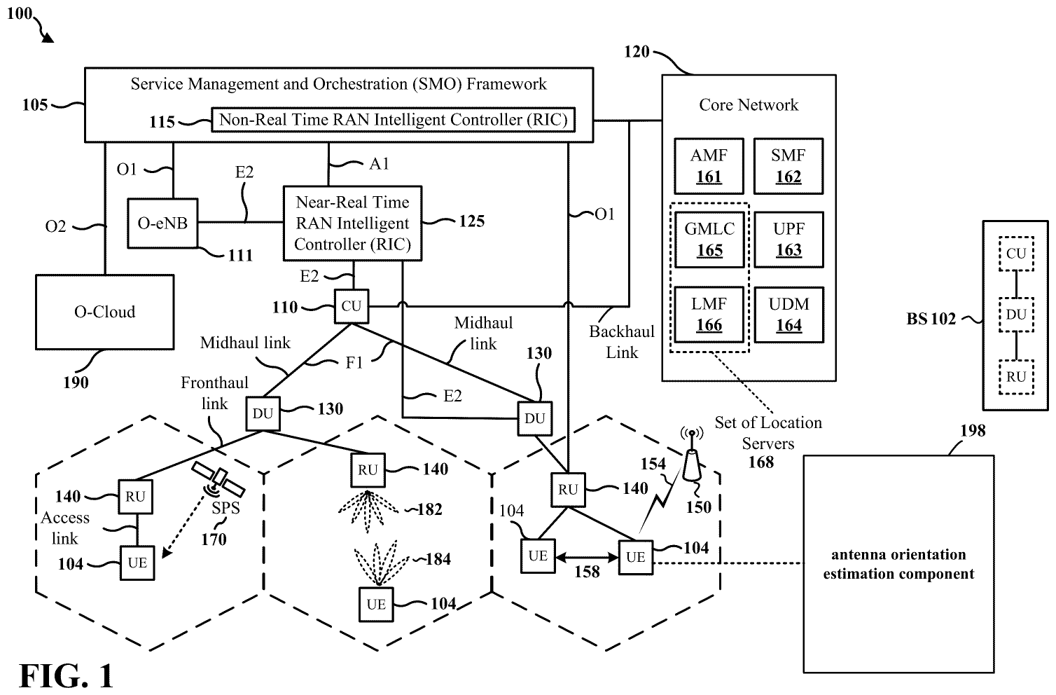

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and a velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an antenna orientation estimation component 198 that may be configured to receive a first set of beacon signals via an antenna at the UE. Each of the first set of beacon signals may be associated with a corresponding indication of an expected beacon location. The antenna orientation estimation component 198 may be configured to calculate an orientation of the antenna based on the first set of beacon signals. Although the following description may be focused on omnidirectional antennas, the concepts described herein may be applicable to other similar devices, such as unidirectional antennas. Although the following description may be focused on 5G NR, the concepts described herein may be applicable to other similar areas, such as LTE, LTE-A, CDMA, GSM, and other wireless technologies.

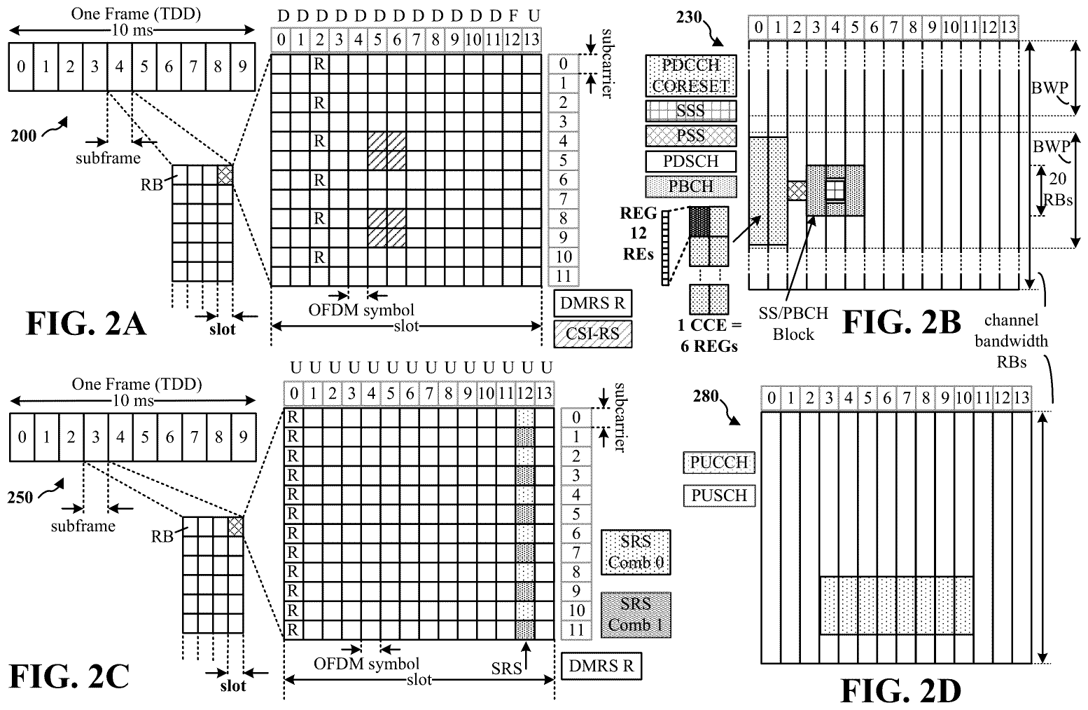

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology 1.1=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

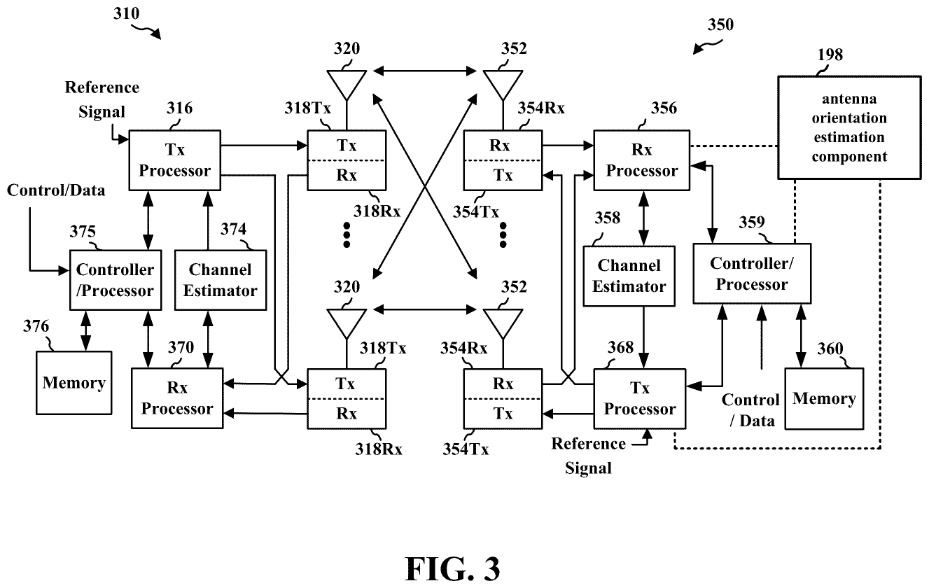

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission. The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the antenna orientation estimation component 198 of FIG. 1.

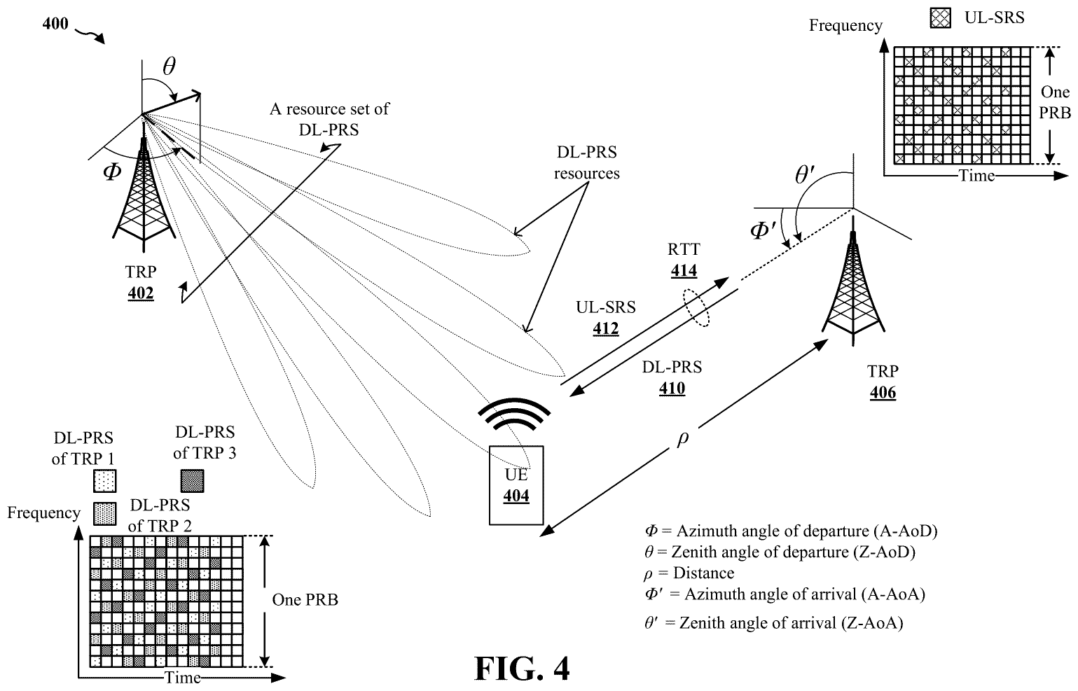

FIG. 4 is a diagram 400 illustrating an example of a UE positioning based on reference signal measurements. The UE 404 may transmit UL-SRS 412 at time T_{SRS_Tx} and receive DL positioning reference signals (PRS) (DL-PRS) 410 at time T_{PRS_Rx}. The TRP 406 may receive the UL-SRS 412 at time T_{SRS_Rx} and transmit the DL-PRS 410 at time T_{PRS_Tx}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_Rx}−T_{PRS_Tx}|−|T_{SRS_Tx}−T_{PRS_Rx}∥. Accordingly, multi-RTT positioning may make use of the UE Rx-Tx time difference measurements (i.e., |T_{SRS_Tx}−T_{PRS_Rx}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_Rx}−T_{PRS_Tx}|) and UL-SRS-RSRP at multiple TRPs 402, 406 of uplink signals transmitted from UE 404. The UE 404 may measure the UE Rx-Tx time difference measurements using assistance data received from the positioning server. The UE 404 may measure the DL-PRS-RSRP of the received signals using assistance data received from the positioning server. The TRP 402 and/or TRP 406 may measure the gNB Rx-Tx time difference measurements using assistance data received from the positioning server. The TRP 402 and/or TRP 406 may measure the UL-SRS-RSRP of the received signals using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) of downlink signals received from multiple TRPs 402, 406 at the UE 404. DL-TDOA positioning may make use of the DL-PRS-RSRP of downlink signals received from multiple TRPs 402, 406 at the UE 404. The UE 404 may measure the DL RSTD of the received signals using assistance data received from the positioning server. The UE 404 may measure the DL-PRS-RSRP of the received signals using assistance data received from the positioning server. The resulting measurements may be used along with other configuration information to locate the UE 404 in relation to the neighboring TRPs 402, 406.

UL-TDOA positioning may make use of the UL relative time of arrival (RTOA) at multiple TRPs 402, 406 of uplink signals transmitted from UE 404. UL-TDOA positioning may make use of the UL-SRS-RSRP at multiple TRPs 402, 406 of uplink signals transmitted from UE 404. The TRP 402 and/or TRP 406 may measure the UL-RTOA of the received signals using assistance data received from the positioning server. The TRP 402 and/or TRP 406 may measure the UL-SRS-RSRP of the received signals using assistance data received from the positioning server. The resulting measurements may be used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

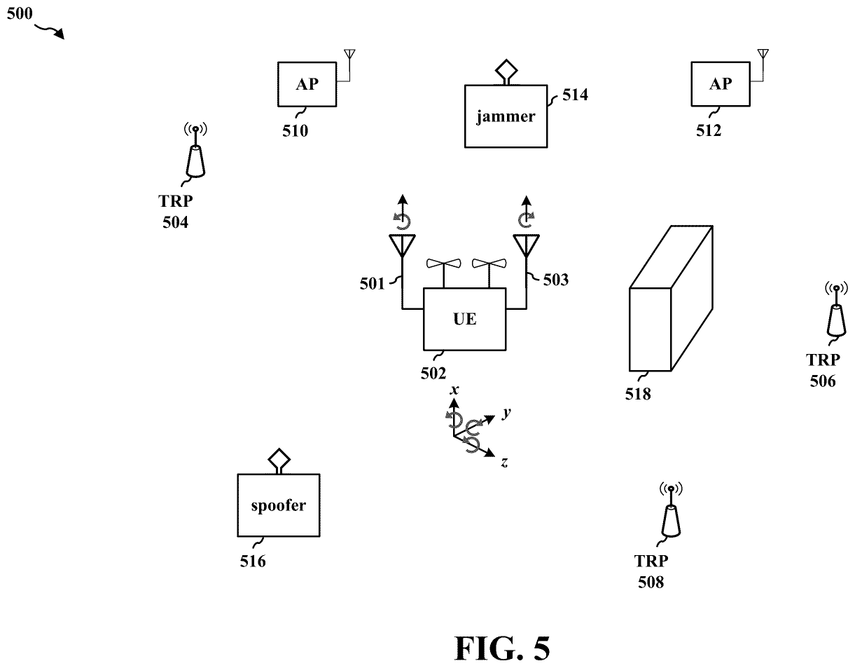

FIG. 5 is a diagram 500 illustrating an example of a UE 502 with an antenna 501 and an antenna 503 configured to communicate with a plurality of wireless devices in a wireless communications system. The wireless communications system may include a TRP 504, a TRP 506, a TRP 508, an AP 510, and an AP 512. The UE 502 may communicate with any of the TRP 504, the TRP 506, the TRP 508, the AP 510, and the AP 512 using one of the antenna 501 or the antenna 503. While the UE 502 is shown with two antennas, the UE 502 may have one antenna, or more than two antennas, in other aspects, which may be configured to communicate with any of the TRP 504, the TRP 506, the TRP 508, the AP 510, and the AP 512.

The antenna 501 or the antenna 503 may be an omnidirectional or a bidirectional antenna. An omnidirectional antenna may be a class of antenna configured to radiate radio power in all directions perpendicular to an axis. A directional antenna or a beam antenna may be a class of antenna configured to radiate or receive greater power in one or more specific directions. A directional antenna may enable the UE 502 to have an increased performance and/or reduced interference in the one or more specific directions of the directional antenna. In other words, an omnidirectional antenna may receive signals from all directions while a directional antenna may pull in signals better in one direction, or in specific directions. In some aspects, a directional antenna may have a ground plane that reduces performance/interference from signals transmitted below the ground plane. In some aspects, a UE having multiple directional antenna may have a multi-antenna beamforming capability.

One or more interfering conditions may prevent the UE 502 from effectively communicating with one or more of the TRP 504, the TRP 506, the TRP 508, the AP 510, and the AP 512 using one of the antenna 501 or the antenna 503. In one aspect, the UE 502 may be configured to communicate with the AP 510 or the AP 512 via the antenna 501 or the antenna 503, but the jammer 514 may interfere with the UE 502 receiving communications from the AP 510 or the AP 512. In another aspect, the UE 502 may be configured to communicate with the AP 510 via the antenna 501 or antenna 503, but the TRP 504 may interfere with the UE 502 receiving communications from the AP 510 via the antenna 501. The TRP 504 may not interfere with the UE 502 receiving communications from the AP 510 via the antenna 503. In some aspects, the UE 502 may be configured to communicate with the TRP 508 via the antenna 501 or the antenna 503, but the spoofer 516 may spoof the cell ID of TRP 508. The UE 502 may be unable to differentiate communications between the TRP 508 and the spoofer 516. In some aspects, the UE 502 may be configured to communicate with the TRP 506 via the antenna 503 or the antenna 501, but the block 518 may interfere with communications between the UE 502 and the TRP 506. The UE 502 may be able to communicate with the TRP 506 using the AP 512 as a relay. In some aspects, the UE 502 may be configured to communicate with the TRP 508 via the antenna 501 or the antenna 503, but the block 518 may interfere with communications between the antenna 503 and the TRP 508. The block 518 may not interfere with communications between the antenna 501 and the TRP 508.

The UE 502 may be configured to perform one or more actions or maneuvers to prevent or minimize an interfering condition from effectively communicating with one or more of the TRP 504, the TRP 506, the TRP 508, the AP 510, and the AP 512 using one of the antenna 501 or the antenna 503. In one aspect, the UE 502 may be configured to change its position. For example, if the block 518 interferes with communications between the UE 502 and the TRP 506, the UE 502 may be configured to move to the right side of the block 518 to prevent the block 518 from interfering with communications with the UE 502. In another example, if the jammer 514 interferes with communications between the UE 502 and the AP 510, the UE 502 may be configured to move outside the range of the jammer 514, but within range of the AP 510, or may be configured to move to a position where the signal of the AP 510 is far stronger than the signal from the jammer 514. If the UE 502 changes its position, the UE 502 also changes the position of the antenna 501 and the antenna 503. In one aspect, the UE 502 may be configured to change its orientation. For example, the UE 502 may be configured to rotate along the x-axis, y-axis, and/or z-axis shown below the UE 502. One or both of the antenna 501 or the antenna 503 may be a directional antenna. Thus, changing an orientation of the UE 502 may change an orientation of the antenna 501 and/or the antenna 503, which may change a directional strength of the antenna 501 and/or the antenna 503 to transmit or receive communications in one or more directions. For example, if the spoofer 516 is spoofing the signal from the TRP 508, the UE 502 may reorient its orientation such that the antenna 503 faces towards the TRP 508 and away from the spoofer 516, and the antenna 501 faces away from the spoofer 516. In another example, if the TRP 504 interferes with the UE 502 receiving a signal from the AP 510, the UE 502 may reorient its orientation such that the antenna 501 faces towards the AP 510 and away from the TRP 504, and the antenna 503 faces away from the TRP 504. In another aspect, the UE 502 may be configured to change a direction of the antenna 501 and/or the antenna 503. For example, the UE 502 may be configured to rotate the antenna 501 along the axis shown above the antenna 501, and may be configured to rotate the antenna 503 along the axis shown above the antenna 503. Changing a direction of the antenna 501 and/or the antenna 503 may improve the UE 502's ability to focus a direction of the antenna 501 and/or the antenna 503 towards a wireless device it is configured to communicate with and away from a wireless device that interferes with the UE 502's ability to communicate. For example, if the jammer 514 interferes with the UE 502's ability to receive signals from the AP 512, the UE 502 may rotate a direction of the antenna 503 to focus on the AP 512 and away from the jammer 514, and may rotate a direction of the antenna 501 to focus away from the jammer 514. In some aspects, the UE 502 may be configured to communicate with a wireless device using one antenna and not another antenna. For example, if the block 518 interferes with communication between the antenna 503 and the TRP 508, but does not interfere with communication between the antenna 501 and the TRP 508, the UE 502 may be configured to communicate with the TRP 508 using the antenna 501 and not with the antenna 503, saving power at the UE 502.

The UE 502 may use positioning information to perform one or more actions or maneuvers to prevent or minimize an interfering condition. For example, for the UE 502 to change its position such that the block 518 does not interfere with communications between the UE 502 and the TRP 506, the UE 502 may use its position relative to the block 518 and the TRP 506 to calculate a new position where the block 518 does not interfere with communications between the UE 502 and the TRP 506. The UE 502 may be able to determine its position relative to the block 518 and the TRP 506 by moving to several positions and transmitting/receiving positioning signals and/or other reference signals (RSs) with the TRP 506. The UE 502 may also initialize an inertial measurement unit (IMU) by performing translational movement to determine its direction relative to the block 518 and the TRP 506. Such translational movement of the UE 502 may also initialize a GNSS system or a GNSS/IMU sensor fusion system for the UE 502 to perform device orientation estimation. However, performing such translational movement may be power-intensive and time-consuming. It may be beneficial for the UE 502 to determine its position relative to the block 518 and the TRP 506 without moving to several positions and transmitting/receiving positioning signals and/or other RSs with the TRP 506. In some aspects, the UE 502 may be a vehicle, or may be mounted to a vehicle, and the direction of the vehicle may not be known during a static start. Navigation of such a vehicle during a static start might be inaccurate if the UE 502 does not know what direction the vehicle is facing until the vehicle starts moving. It may be beneficial for the UE 502 to perform quick orientation estimation to resolve this issue. Moreover, performing quick orientation of the UE 502 may improve RF signal multipath (e.g., non-line-of-sight (NLOS)), interference (e.g., jamming, unintentional interference), or spoofing systems and methods, as the UE 502 may know its position relative to key objects (e.g., a TRP, an AP, a block) in a wireless system at a static start. A spoofing device may be a device configured to mimic a wireless device, for example by transmitting a unique identifier (UID) with a transmission to mimic the wireless device. In one aspect, the spoofer 516 may transmit signals with a MAC address of a transmitter of the TRP 508. A jamming device may be a device configured to interfere with reception of a wireless signal from a wireless device, for example by transmitting an interfering signal using one or more frequency bands used by a wireless device. In one aspect, the jammer 514 may transmit an interfering wireless signal using a set of bands used by the AP 512 to interfere with a signal transmitted by the AP 512 using the set of bands. A beacon signal may be any signal transmitted by a wireless device that is uniquely associated with the wireless device. The beacon signal may include a UID of the wireless device, or a location of the wireless device, which is different from a UID or location of another wireless device.

In some aspects, the UE 502 may be configured to customize a directional antenna to estimate device orientation by analyzing beacon signals with corresponding location tags. In some aspects, the UE 502 may be configured to customize a directional antenna to detect interference conditions (e.g., jamming, spoofing, NLOS conditions) by changing a position, orientation, or direction of an antenna, or by changing what antenna it uses. The UE 502 may receive a first set of beacon signals via an antenna at the UE. Each of the first set of beacon signals is associated with a corresponding indication of an expected beacon location. The UE 502 may calculate an orientation of the antenna based on the first set of beacon signals. The UE 502 may calculate a forward-facing direction of an object based on the orientation of the antenna and an attachment configuration of the antenna relative to the object. The UE 502 may change at least one of a position, the orientation, or a direction of the antenna. The UE 502 may receive a second set of beacon signals after the at least one processor changes at least one of the position, the direction, or the orientation of the antenna. Each of the second set of beacon signals may be associated with the corresponding indication of the expected beacon location. The UE 502 may calculate at least one of a set of interfering condition parameters, a set of spoofing condition parameters, or a set of NLOS condition parameters based on the first set of beacon signals and the second set of beacon signals.

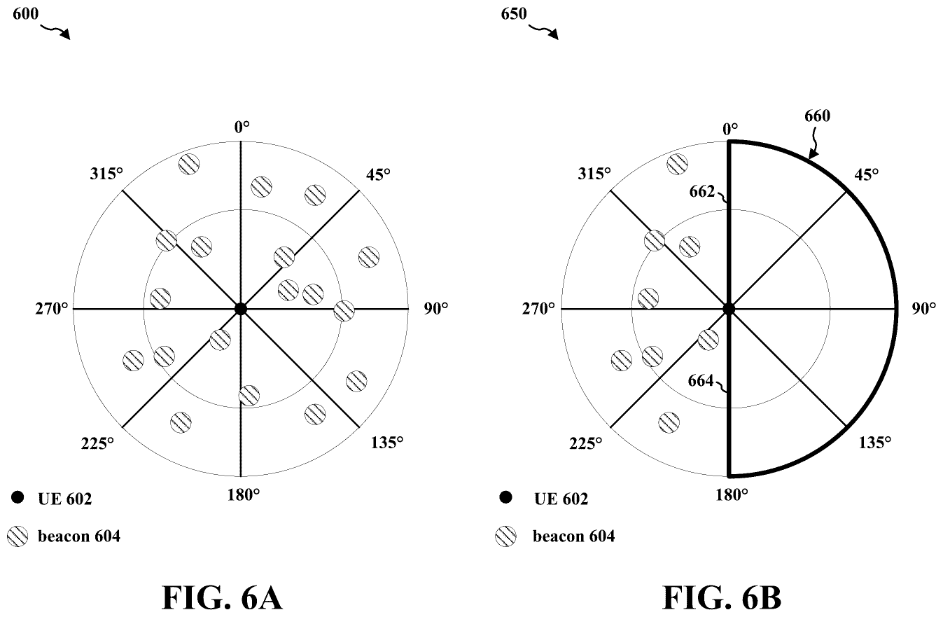

FIG. 6A is a diagram 600 illustrating an example of a sky-plot generated from a receiver of a UE 602, such as the UE 104 in FIG. 1 or the UE 502 in FIG. 5. The UE 602 may have an omnidirectional antenna, or multiple directional antennas, that may be configured to track available RF beacon signals, for example GPS signals or NTN signals. The beacon signals may contain location information of the transmitter. The beacon signals may be transmitted from, for example, GNSS space vehicles (GNSS SVs), low-earth orbit (LEO) satellites, base stations, cellular stations, APs, Wi-Fi stations, or amateur radio repeaters. In some aspects, the beacon signals may contain a unique identifier (ID), such as a cell ID, which may correlate with a known location. For example, the UE 602 may be able to retrieve a table of correlated IDs and locations from a network node or a beacon location database, such as an LMF or a domain name server (DNS). If the UE 602 knows its own location, and the location of beacons around the UE 602 that the UE 602 may receive beacon information from, the UE 602 may be able to generate a sky-plot such as the one shown in diagram 600, having the UE 602 located in the center and a plurality of beacons 604 positioned around the UE 602.

While the UE 602 may understand its location relative to the plurality of beacons 604, the UE 602 may not know an orientation of its antenna using the sky plot shown in diagram 600.

FIG. 6B is a diagram 650 illustrating an example of a sky-plot generated from another receiver of a UE 602 having a directional antenna. The UE 602 may have a directional antenna with a plate that blocks receptions along a 180° angular area. The sky plot may also show a plurality of beacons 604 positioned around the UE 602, but may also illustrate a gap area 660 that does not have beacon signals. The UE 602 may be able to determine its orientation based on the location information of visible beacon signals in the diagram 650 having the gap area 660. In aspects where the UE 602 has a directional antenna and an omnidirectional antenna communicating with a GNSS, the UE 502 may be configured to compare a visible GNSS SV sky-plot generated using its directional antenna against a visible GNSS SV sky-plot generated using its omnidirectional antenna. In aspects where the UE 602 may be able to retrieve a set of beacon locations from a beacon location database, the UE 602 may be configured to compare a visible sky-plot generated using its directional antenna against a sky-plot of expected beacon locations. For example, the UE 602 may estimate a first reception boundary 662 of the gap area 660 to be at 0° (or 360°) and a second reception boundary 664 of the gap area 660 to be at 180°. In other words, the beacons 604 in FIG. 6B may be a subset of the beacons 604 in FIG. 6A. In some aspects, the UE 602 may estimate the first reception boundary 662 of the gap area 660 to be at 0° (or 360°) and the second reception boundary 664 of the gap area 660 to be at 180° based on a cluster pattern of the beacons 604. A cluster pattern may be any pattern of a set of beacon locations within a defined area that has more beacon locations than a different defined area of equal size. Such a determination depends upon the density of the received beacons signals. The UE 602 may then estimate a directional angle of its directional antenna to be between the first reception boundary 662 and the second reception boundary 664, which is 270° (between 180° and 360°). If the UE 602 knows which direction a directional antenna is mounted to an object, such as a manned vehicle, an unmanned vehicle, a ground vehicle, an unmanned aerial vehicle (UAV), an Internet of Things (IoT) device, or a wearable device, the UE 602 may be able to calculate a forward-facing direction of the object based on the attachment configuration of the antenna relative to the object. For example, if the directional antenna is mounted to the front bumper of a vehicle, the UE 602 may be configured to estimate that the vehicle is facing 270°. In another aspect, if the directional antenna is mounted to face a left side of a vehicle, the UE 602 may be configured to estimate that the vehicle is facing 0° (or 360°). Such a system may be used to initialize a GNSS system or a GNSS/IMU sensor fusion system at static start.

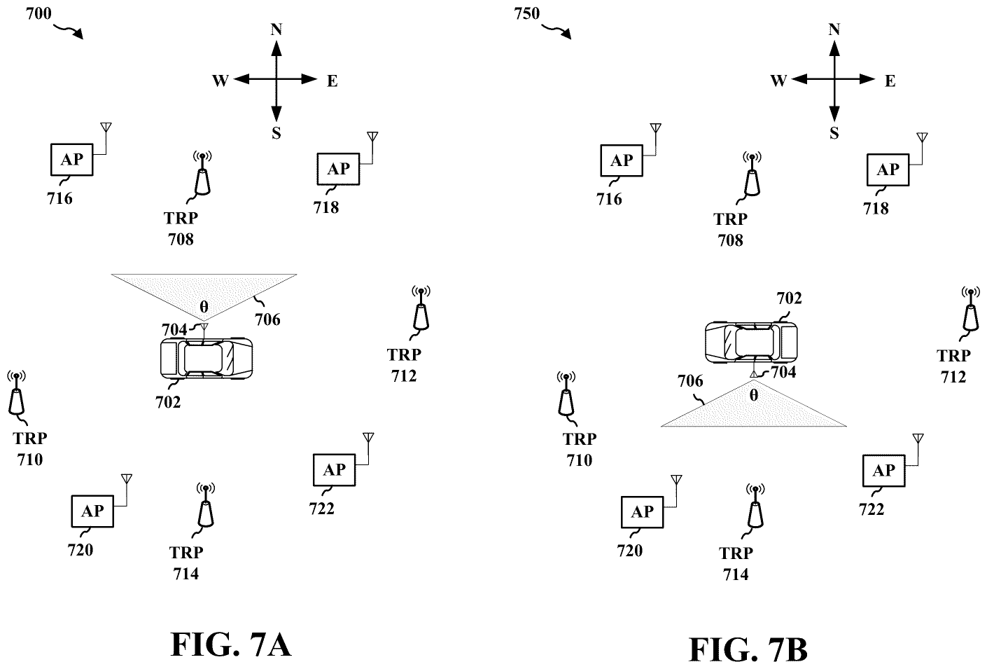

FIG. 7A is a diagram 700 illustrating an example of a UE 702 with a directional antenna 704 configured to communicate with one or more wireless devices, such as the TRP 708, the TRP 710, the TRP 712, the TRP 714, the AP 716, the AP 718, the AP 720, and the AP 722. The UE 702 may be a terrestrial vehicle, such as a car, which may be configured to receive wireless signals from terrestrial base stations, for example via LTE, NR, or Wi-Fi signals. The UE 702 may be configured to retrieve one or more locations of nearby beacon transmitters from one or more sources. For example, the UE 702 may be configured to retrieve locations of the TRP 708, the TRP 710, the TRP 712, and the TRP 714 from an LMF and may be configured to retrieve locations of the AP 716, the AP 718, the AP 720, and the AP 722 from a DNS. Thus, the UE 702 may know locations of nearby beacon transmitters even if no signal is received by the UE 702 from the beacon transmitter.

The directional antenna 704 of the UE 702 may have a known directional angle θ, which the UE 702 may use to calculate the expected width of a reception area 706, within which the directional antenna 704 may receive signals from beacons. The reception area 706 is understood to extend to the limits of where the directional antenna 704 may receive a beacon signal. In other words, the UE 702 may use the known directional angle θ to define an antenna direction pattern for the directional antenna 704.

The UE 702 may be configured to estimate an orientation of the directional antenna 704 by analyzing the locations of all received signals, locations of nearby beacon transmitters, and an antenna direction pattern of the directional antenna 704. In one aspect, the UE 702 may be a customized automotive antenna on a car that receives three RF beacon signals from the AP 716, the TRP 708, and the AP 718, respectively. The UE 702 may determine that the vehicle is facing east based on its reception of beacon signals from the AP 716, the TRP 708, and the AP 718, knowing that, based on the location of the UE 702, the UE 702 may receive signals from the TRP 708, the TRP 710, the TRP 712, the TRP 714, the AP 716, the AP 718, the AP 720, and the AP 722.

FIG. 7B is a diagram 750 illustrating an example of the UE 702 in FIG. 7A in a different configuration. Here, the directional antenna 704 may receive beacon signals from the AP 720, the TRP 714, and the AP 722. The UE 702 may determine that the vehicle is facing west based on its reception of beacon signals from the AP 720, the TRP 714, and the AP 722, knowing that, based on the location of the UE 702, the UE 702 may receive signals from the TRP 708, the TRP 710, the TRP 712, the TRP 714, the AP 716, the AP 718, the AP 720, and the AP 722. Such a method may provide a quick constraint for initialization of an IMU sensor at static start. The resolution of such a method may be dependent upon a resolution of the antenna directivity and the spatial density of nearby RF beacons.

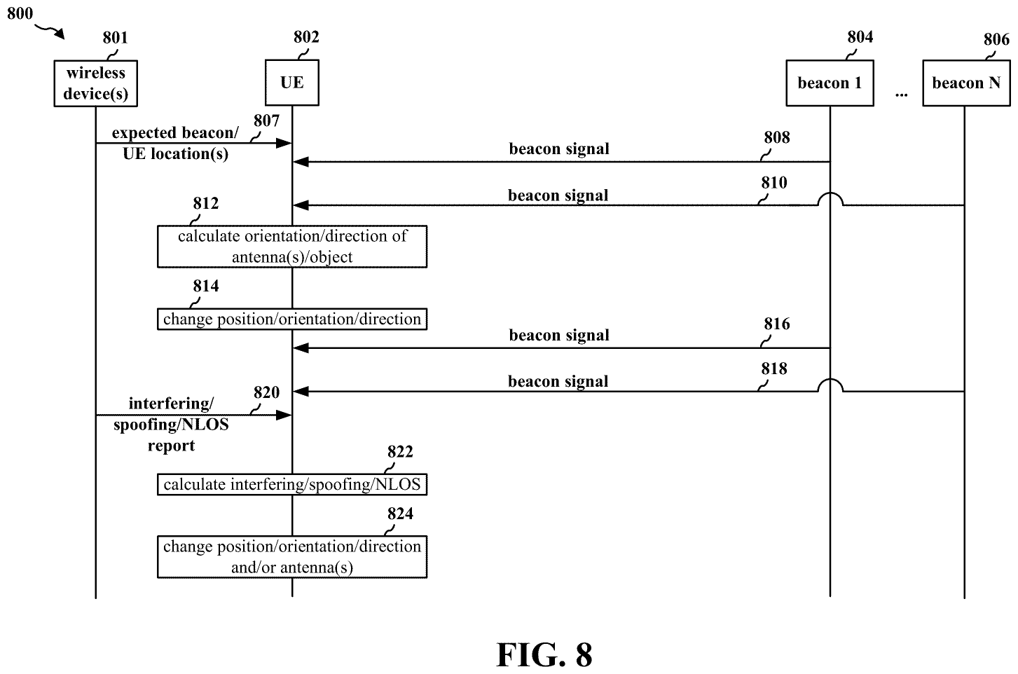

FIG. 8 is a communications flow diagram 800 of a UE 802 in a wireless system. The UE 802 may be configured to receive beacon signals from a plurality of beacons 1 to N, shown here as two beacons, beacon 1 804 and beacon N 806. While two beacons are shown in communications flow diagram 800, the UE 802 may receive beacon signals from many more beacons than two beacons. The beacon 1 804 may transmit the beacon signal 808 to the UE 802. The UE 802 may receive the beacon signal 808 from the beacon 1 804. The beacon signal 808 may include an indicator of the location of the beacon 1 804. The beacon N 806 may transmit the beacon signal 810 to the UE 802. The UE 802 may receive the beacon signal 810 from the beacon N 806. The beacon signal 810 may include a location of the beacon N 806. The UE 802 may be configured to determine its location using the beacon signals. For example, the UE 802 may receive a set of beacon signals from GNSS SVs to determine its GPS coordinates, or may receive a set of beacon signals from APs to determine its location relative to the locations of the APs. The UE 802 may use an indicator of a location of a beacon to generate a map of expected beacon locations for each beacon.

In some aspects, the UE 802 may receive location information 807 from one or more wireless devices 801. The one or more wireless devices 801 may transmit the location information 807 to the UE 802. The one or more wireless devices 801 may be, for example, a network node, an AP, an LMF, a road-side unit (RSU), a DNS, or another UE. The one or more wireless devices 801 may include one or more beacon databases that may be used to retrieve indicators of expected beacon locations. The location information 807 may include one or more expected beacon locations that the UE 802 may use to map out beacons near to the UE 802. The location information 807 may include a location of the UE 802. Whether received as the location information 807 from the one or more wireless devices 801 or determined by the UE 802 from the beacon signals 808 and 810, the UE 802 may determine its position relative to the beacon 1 804 and beacon N 806.

At 812, the UE 802 may calculate an orientation of one or more antennas, a direction of one or more antennas, an orientation of an object that the one or more antennas are mounted to, or a direction of an object to which the one or more antennas are mounted based on the beacon signals 808 and 810. For example, the UE 802 may estimate a first and second reception boundary, such as the first reception boundary 662 and the second reception boundary 664 in FIG. 6B, based on a cluster pattern of the beacon signals received by an antenna of the UE 802, such as the beacon signals 808 and the beacon signals 810. The UE 802 may determine the direction of an antenna receiving the beacon signals 808 and 810 to be between the first boundary and the second boundary.

In some aspects, the UE 802 may use the location information (e.g., received as the location information 807, determined by the UE 802, or derived from the beacon signals 808 and 810) to determine expected beacon locations around the UE 802. For example, the UE 802 may determine expected beacon locations within a threshold distance of the UE 802. The UE 802 may then compare the beacon signals by one or more antennas of the UE 802, such as the beacon signals 808 and 810, with the expected beacon locations to determine which beacons of the expected beacon locations transmitted signals that were received by the UE 802. The UE 802 may estimate a first and second reception boundary based on the expected beacon locations and the received beacon signals to estimate a direction of the antenna that received the beacon signals. The UE 802 may use the estimated orientation/direction of the one or more antennas to determine an orientation/direction of any objects that the antennas are mounted to, for example a terrestrial vehicle or a UAV. The UE 802 may determine this direction at a static start, which may be used to initialize an IMU, a GNSS, or a GNSS/IMU sensor fusion system of the UE 802 at a static start. At 814, the UE 802 may change a position, an orientation, and/or a direction of one or more antennas of the UE 802. In some aspects, the change may be random, and in other aspects, the change may be based on the beacon signals 808 and 810. For example, the UE 802 may expect a signal from a TRP that its antenna is directed towards, but may not have received a beacon signal from the TRP, and so may assume that there is a block between the UE 802 and the TRP that it expected a beacon signal from. The UE 802 may move its position, orientation, or direction of one or more antennas of the UE 802 to move around such a block. By changing an antenna main beam orientation or the orientation of the UE 802 that the antenna is mounted to, the UE 802 may detect and mitigate potential interference, spoofing, and/or NLOS conditions by modeling the expected signals being tracked as a function of time or direction. When RF interference or spoofing is detected, the UE 802 may perform one or more position, orientation, or direction maneuvers to avoid interference, spoofing, or blocking.

After the UE 802 changes the position, orientation, and/or direction of one or more antennas at 814, the UE 802 may receive beacon signals. The beacon 1 804 may transmit the beacon signal 816 to the UE 802. The UE 802 may receive the beacon signal 816 from the beacon 1 804. The beacon N 806 may transmit the beacon signal 818 to the UE 802. The UE 802 may receive the beacon signal 818 from the beacon N 806. At 822, the UE 802 may calculate a set of interfering condition parameters, a set of spoofing condition parameters, or a set of NLOS condition parameters based on the beacon signals 808 and 810, the change in position, orientation, and/or direction of one or more antennas at 814, and the beacon signals 816 and 818. For example, the UE 802 may have received interference from a jammer or another wireless device when it received the beacon signals 808 and 810, but may not have received interference when it received the beacon signals 816 and 818, and may then determine a location of a jamming or an interfering device. In another example, the UE 802 may have received a spoofing signal from a location as beacon signal 808 and the same spoofing signal from the location as beacon signal 816, and may triangulate the beacon signals to determine the location of the spoofing device. The UE 802 may know that the spoofing device is not a legitimate beacon by comparing the calculated location of the spoofing device against an expected beacon location. In another example, the UE 802 may not receive a beacon signal from a beacon before it changed the position, orientation, and/or direction of one or more antennas at 814, and may receive a beacon signal from a beacon after it changed the position, orientation, and/or direction of one or more antennas at 814, which allows the UE 802 to identify a location of a block. In some aspects, the UE 802 may change the position, orientation, and/or direction of one or more antennas at 824 to fine-tune a determined location of an interfering device, a spoofing device, or a blocking device. In other words, when RF interference is detected, the UE 802 may perform a series of orientation maneuvers to avoid or minimize the effects of continued jamming, spoofing, and/or blocking. In some aspects, the UE 802 may not change the position, orientation, and/or direction of one or more antennas at 814 to determine a location of an interfering device, a spoofing device, or a blocking device. Instead, the UE 802 may receive one or more reports 820 from one or more wireless devices 801. The report may include at least one of an interfering condition associated with the data already collected by the UE 802, which the UE 802 may use to determine a location of an interfering device, a spoofing device, or a blocking device. The report may include, for example, a sky-plot or a model of a UE, a set of expected beacon locations, and a set of received beacon signals from a UE having an antenna with a different position, orientation, and/or direction from an antenna of the UE 802. In other words, with a crowdsourcing technique, the UE 802 may locate and/or label a spoofer source, jammer source, and/or blocker source.

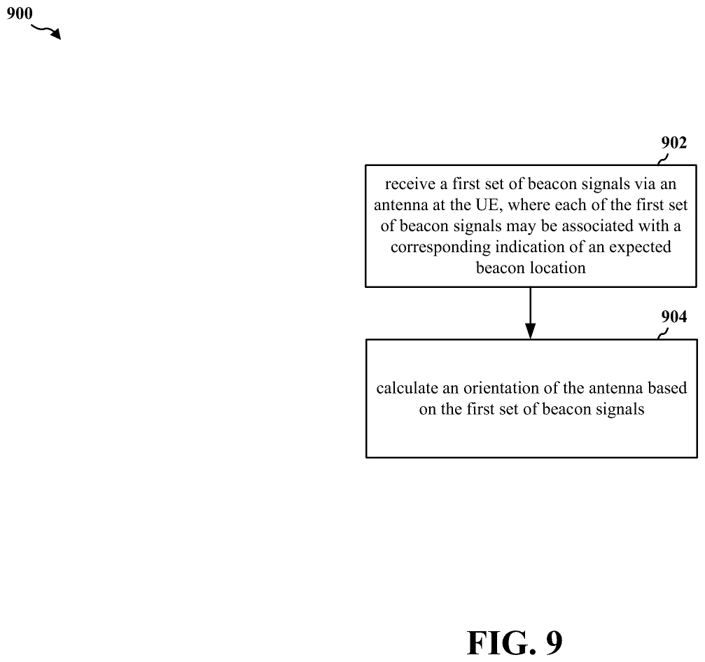

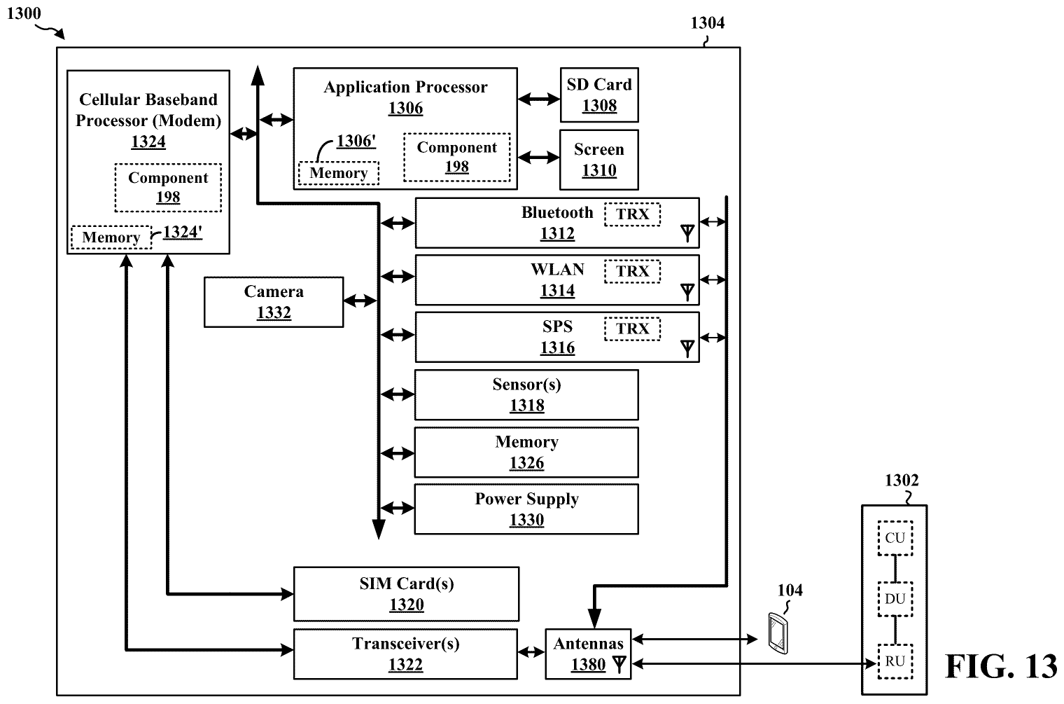

The UE 802 may be configured to tilt and/or rotate one or more antennas to block or minimize the effects of a jammer or a spoofer on its communications. In some aspects, the UE 802 may have two or more antennas facing different directions, which may provide the UE 802 higher spatial coverage of RF signals. The RF tracking expectation between the different antennas may be different based on real-time information that changes as the UE changes the position, orientation, and/or direction of one or more antennas at 814 and 824. Having multiple antennas may increase the direction diversity. If the UE 802 receives beacons from NTN satellites, the UE 802 may also mitigate unintentional RF interferences from NTN wireless devices. FIG. 9 is a flowchart 900 of a method of wireless communication. The method may be performed by a UE (e.g., the UE 104, the UE 350, the UE 404, the UE 502, the UE 602, the UE 702, the UE 802; the apparatus 1304). At 902, the UE may receive a first set of beacon signals via an antenna at the UE. Each of the first set of beacon signals may be associated with a corresponding indication of an expected beacon location. For example, 902 may be performed by the UE 802 in FIG. 8, which may receive the beacon signals 808 and 810 via an antenna at the UE 802. Each of the beacon signals 808 and 810 may be associated with a corresponding indication of an expected beacon location, for example by being included in the beacon signals 808 and 810 or by being associated with an expected beacon location from the location information 807. Moreover, 902 may be performed by the component 198 in FIG. 13.

At 904, the UE may calculate an orientation of the antenna based on the first set of beacon signals. For example, 904 may be performed by the UE 802 in FIG. 8, which may, at 812, calculate an orientation of the antenna based on the beacon signals 808 and 810. Moreover, 904 may be performed by the component 198 in FIG. 13.

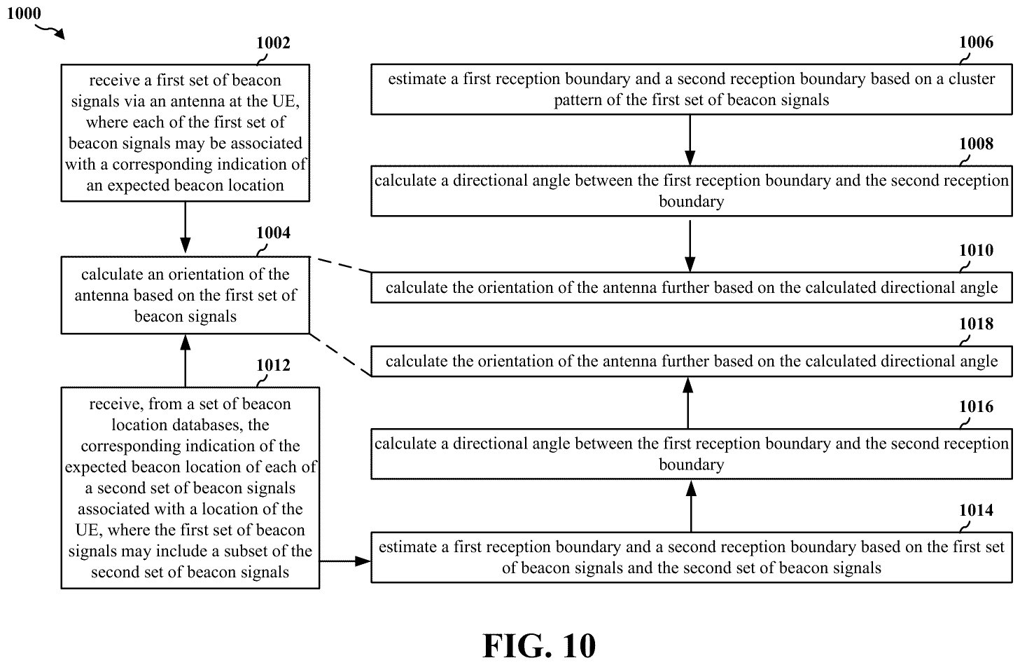

FIG. 10 is a flowchart 1000 of a method of wireless communication. The method may be performed by a UE (e.g., the UE 104, the UE 350, the UE 404, the UE 502, the UE 602, the UE 702, the UE 802; the apparatus 1304). At 1002, the UE may receive a first set of beacon signals via an antenna at the UE. Each of the first set of beacon signals may be associated with a corresponding indication of an expected beacon location. For example, 1002 may be performed by the UE 802 in FIG. 8, which may receive the beacon signals 808 and 810 via an antenna at the UE 802. Each of the beacon signals 808 and 810 may be associated with a corresponding indication of an expected beacon location, for example by being included in the beacon signals 808 and 810 or by being associated with an expected beacon location from the location information 807. Moreover, 1002 may be performed by the component 198 in FIG. 13.

At 1004, the UE may calculate an orientation of the antenna based on the first set of beacon signals. For example, 1004 may be performed by the UE 802 in FIG. 8, which may, at 812, calculate an orientation of the antenna based on the beacon signals 808 and 810. Moreover, 1004 may be performed by the component 198 in FIG. 13. At 1006, the UE may estimate a first reception boundary and a second reception boundary based on a cluster pattern of the first set of beacon signals. For example, 1006 may be performed by the UE 802 in FIG. 8, which may estimate a first reception boundary and a second reception boundary based on a cluster pattern of the first set of beacon signals. Moreover, 1006 may be performed by the component 198 in FIG. 13.

At 1008, the UE may calculate a directional angle between the first reception boundary and the second reception boundary. For example, 1008 may be performed by the UE 802 in FIG. 8, which may calculate a directional angle between the first reception boundary and the second reception boundary. Moreover, 1008 may be performed by the component 198 in FIG. 13.

At 1010, the UE may calculate the orientation of the antenna further based on the calculated directional angle. For example, 1010 may be performed by the UE 802 in FIG. 8, which may calculate the orientation of the antenna further based on the calculated directional angle. Moreover, 1010 may be performed by the component 198 in FIG. 13.

At 1012, the UE may receive, from a set of beacon location databases, the corresponding indication of the expected beacon location of each of a second set of beacon signals associated with a location of the UE. The first set of beacon signals may include a subset of the second set of beacon signals. For example, 1012 may be performed by the UE 802 in FIG. 8, which may receive, from a set of beacon location databases, the corresponding indication of the expected beacon location of each of a second set of beacon signals associated with a location of the UE. The first set of beacon signals may include a subset of the second set of beacon signals. Moreover, 1012 may be performed by the component 198 in FIG. 13.

At 1014, the UE may estimate a first reception boundary and a second reception boundary based on the first set of beacon signals and the second set of beacon signals. For example, 1014 may be performed by the UE 802 in FIG. 8, which may estimate a first reception boundary and a second reception boundary based on the first set of beacon signals and the second set of beacon signals. Moreover, 1014 may be performed by the component 198 in FIG. 13.

At 1016, the UE may calculate a directional angle between the first reception boundary and the second reception boundary. For example, 1016 may be performed by the UE 802 in FIG. 8, which may calculate a directional angle between the first reception boundary and the second reception boundary. Moreover, 1016 may be performed by the component 198 in FIG. 13.

At 1018, the UE may calculate the orientation of the antenna further based on the calculated directional angle. For example, 1018 may be performed by the UE 802 in FIG. 8, which may calculate the orientation of the antenna further based on the calculated directional angle. Moreover, 1018 may be performed by the component 198 in FIG. 13.

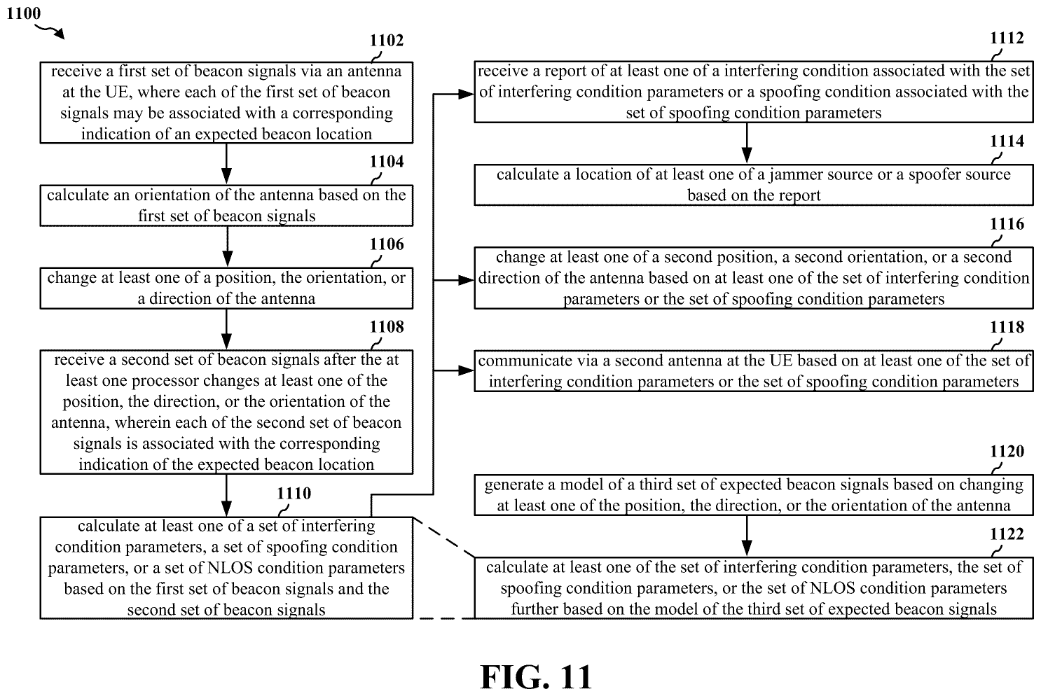

FIG. 11 is a flowchart 1100 of a method of wireless communication. The method may be performed by a UE (e.g., the UE 104, the UE 350, the UE 404, the UE 502, the UE 602, the UE 702, the UE 802; the apparatus 1304). At 1102, the UE may receive a first set of beacon signals via an antenna at the UE. Each of the first set of beacon signals may be associated with a corresponding indication of an expected beacon location. For example, 1102 may be performed by the UE 802 in FIG. 8, which may receive the beacon signals 808 and 810 via an antenna at the UE 802. Each of the beacon signals 808 and 810 may be associated with a corresponding indication of an expected beacon location, for example by being included in the beacon signals 808 and 810 or by being associated with an expected beacon location from the location information 807. Moreover, 1102 may be performed by the component 198 in FIG. 13.

At 1104, the UE may calculate an orientation of the antenna based on the first set of beacon signals. For example, 1104 may be performed by the UE 802 in FIG. 8, which may, at 812, calculate an orientation of the antenna based on the beacon signals 808 and 810. Moreover, 1104 may be performed by the component 198 in FIG. 13. At 1106, the UE may change at least one of a position, the orientation, or a direction of the antenna. For example, 1106 may be performed by the UE 802 in FIG. 8, which may change at least one of a position, the orientation, or a direction of the antenna. Moreover, 1106 may be performed by the component 198 in FIG. 13.

At 1108, the UE may receive a second set of beacon signals after the at least one processor changes at least one of the position, the direction, or the orientation of the antenna. Each of the second set of beacon signals is associated with the corresponding indication of the expected beacon location. For example, 1108 may be performed by the UE 802 in FIG. 8, which may receive a second set of beacon signals after the at least one processor changes at least one of the position, the direction, or the orientation of the antenna. Each of the second set of beacon signals is associated with the corresponding indication of the expected beacon location. Moreover, 1108 may be performed by the component 198 in FIG. 13.

At 1110, the UE may calculate at least one of a set of interfering condition parameters, a set of spoofing condition parameters, or a set of NLOS condition parameters based on the first set of beacon signals and the second set of beacon signals. For example, 1110 may be performed by the UE 802 in FIG. 8, which may calculate at least one of a set of interfering condition parameters, a set of spoofing condition parameters, or a set of NLOS condition parameters based on the first set of beacon signals and the second set of beacon signals. Moreover, 1110 may be performed by the component 198 in FIG. 13.

At 1112, the UE may receive a report of at least one of an interfering condition associated with the set of interfering condition parameters or a spoofing condition associated with the set of spoofing condition parameters. For example, 1112 may be performed by the UE 802 in FIG. 8, which may receive a report of at least one of an interfering condition associated with the set of interfering condition parameters or a spoofing condition associated with the set of spoofing condition parameters. Moreover, 1112 may be performed by the component 198 in FIG. 13.

At 1114, the UE may calculate a location of at least one of a jammer source or a spoofer source based on the report. For example, 1114 may be performed by the UE 802 in FIG. 8, which may calculate a location of at least one of a jammer source or a spoofer source based on the report. Moreover, 1114 may be performed by the component 198 in FIG. 13.

At 1116, the UE may change at least one of a second position, a second orientation, or a second direction of the antenna based on at least one of the set of interfering condition parameters or the set of spoofing condition parameters. For example, 1116 may be performed by the UE 802 in FIG. 8, which may change at least one of a second position, a second orientation, or a second direction of the antenna based on at least one of the set of interfering condition parameters or the set of spoofing condition parameters. Moreover, 1116 may be performed by the component 198 in FIG. 13. At 1118, the UE may communicate via a second antenna at the UE based on at least one of the set of interfering condition parameters or the set of spoofing condition parameters. For example, 1118 may be performed by the UE 802 in FIG. 8, which may communicate via a second antenna at the UE based on at least one of the set of interfering condition parameters or the set of spoofing condition parameters. Moreover, 1118 may be performed by the component 198 in FIG. 13.

At 1120, the UE may generate a model of a third set of expected beacon signals based on changing at least one of the position, the direction, or the orientation of the antenna. For example, 1120 may be performed by the UE 802 in FIG. 8, which may generate a model of a third set of expected beacon signals based on changing at least one of the position, the direction, or the orientation of the antenna. Moreover, 1120 may be performed by the component 198 in FIG. 13.

At 1122, the UE may calculate at least one of the set of interfering condition parameters, the set of spoofing condition parameters, or the set of NLOS condition parameters further based on the model of the third set of expected beacon signals. For example, 1122 may be performed by the UE 802 in FIG. 8, which may calculate at least one of the set of interfering condition parameters, the set of spoofing condition parameters, or the set of NLOS condition parameters further based on the model of the third set of expected beacon signals. Moreover, 1122 may be performed by the component 198 in FIG. 13.

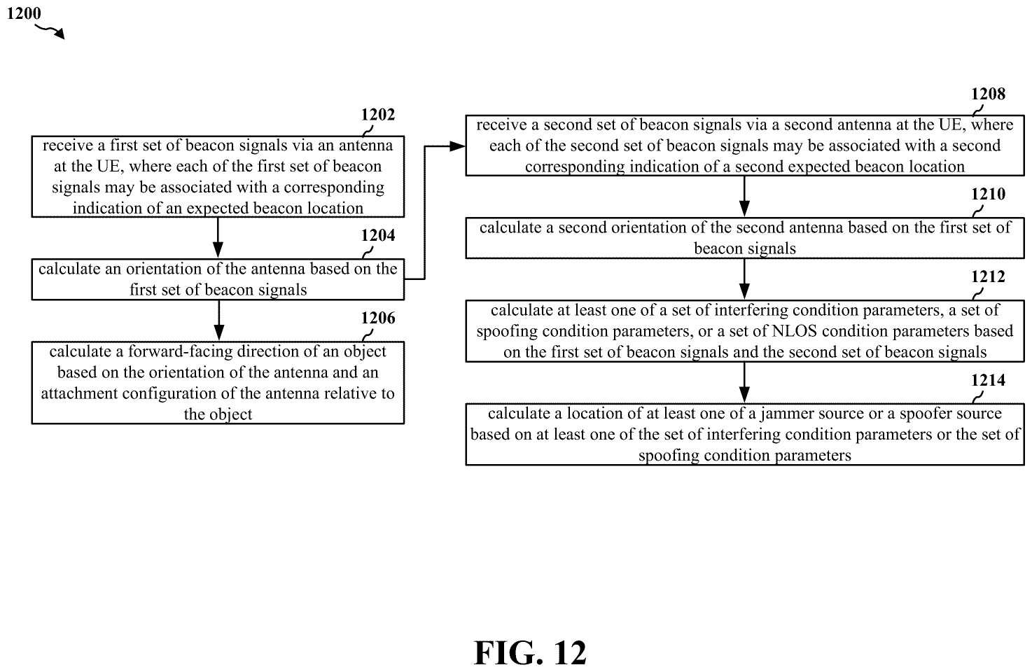

FIG. 12 is a flowchart 1200 of a method of wireless communication. The method may be performed by a UE (e.g., the UE 104, the UE 350, the UE 404, the UE 502, the UE 602, the UE 702, the UE 802; the apparatus 1304). At 1202, the UE may receive a first set of beacon signals via an antenna at the UE. Each of the first set of beacon signals may be associated with a corresponding indication of an expected beacon location. For example, 1202 may be performed by the UE 802 in FIG. 8, which may receive the beacon signals 808 and 810 via an antenna at the UE 802. Each of the beacon signals 808 and 810 may be associated with a corresponding indication of an expected beacon location, for example by being included in the beacon signals 808 and 810 or by being associated with an expected beacon location from the location information 807. Moreover, 1202 may be performed by the component 198 in FIG. 13.

At 1204, the UE may calculate an orientation of the antenna based on the first set of beacon signals. For example, 1204 may be performed by the UE 802 in FIG. 8, which may, at 812, calculate an orientation of the antenna based on the beacon signals 808 and 810. Moreover, 1204 may be performed by the component 198 in FIG. 13. At 1206, the UE may calculate a forward-facing direction of an object based on the orientation of the antenna and an attachment configuration of the antenna relative to the object. For example, 1206 may be performed by the UE 802 in FIG. 8, which may calculate a forward-facing direction of an object based on the orientation of the antenna and an attachment configuration of the antenna relative to the object. Moreover, 1206 may be performed by the component 198 in FIG. 13.

At 1208, the UE may receive a second set of beacon signals via a second antenna at the UE, where each of the second set of beacon signals may be associated with a second corresponding indication of a second expected beacon location. For example, 1208 may be performed by the UE 802 in FIG. 8, which may receive a second set of beacon signals via a second antenna at the UE, where each of the second set of beacon signals may be associated with a second corresponding indication of a second expected beacon location. Moreover, 1208 may be performed by the component 198 in FIG. 13.

At 1210, the UE may calculate a second orientation of the second antenna based on the first set of beacon signals. For example, 1210 may be performed by the UE 802 in FIG. 8, which may calculate a second orientation of the second antenna based on the first set of beacon signals. Moreover, 1210 may be performed by the component 198 in FIG. 13.

At 1212, the UE may calculate at least one of a set of interfering condition parameters, a set of spoofing condition parameters, or a set of NLOS condition parameters based on the first set of beacon signals and the second set of beacon signals. For example, 1212 may be performed by the UE 802 in FIG. 8, which may calculate at least one of a set of interfering condition parameters, a set of spoofing condition parameters, or a set of NLOS condition parameters based on the first set of beacon signals and the second set of beacon signals. Moreover, 1212 may be performed by the component 198 in FIG. 13.

At 1214, the UE may calculate a location of at least one of a jammer source or a spoofer source based on at least one of the set of interfering condition parameters or the set of spoofing condition parameters. For example, 1214 may be performed by the UE 802 in FIG. 8, which may calculate a location of at least one of a jammer source or a spoofer source based on at least one of the set of interfering condition parameters or the set of spoofing condition parameters. Moreover, 1214 may be performed by the component 198 in FIG. 13.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (Rx)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the Tx processor 368, the Rx processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see UE 350 of FIG. 3) and include the additional modules of the apparatus 1304.

As discussed supra, the component 198 may be configured to receive a first set of beacon signals via an antenna at the UE. Each of the first set of beacon signals may be associated with a corresponding indication of an expected beacon location. The component 198 may be configured to calculate an orientation of the antenna based on the first set of beacon signals. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, may include means for receiving a first set of beacon signals via an antenna at the UE. Each of the first set of beacon signals may be associated with a corresponding indication of an expected beacon location. The apparatus 1304 may include means for calculating an orientation of the antenna based on the first set of beacon signals. The apparatus 1304 may include means for estimating a first reception boundary and a second reception boundary based on a cluster pattern of the first set of beacon signals. The apparatus 1304 may include means for calculating the orientation of the antenna based on the first set of beacon signals by calculating the orientation of the antenna by calculating a directional angle between the first reception boundary and the second reception boundary. Each of the first set of beacon signals may include the corresponding indication of the expected beacon location. The apparatus 1304 may include means for receiving, from a set of beacon location databases, the corresponding indication of the expected beacon location of each of a second set of beacon signals associated with a location of the UE. The first set of beacon signals may include a subset of the second set of beacon signals. The apparatus 1304 may include means for estimating a first reception boundary and a second reception boundary based on the first set of beacon signals and the second set of beacon signals. The apparatus 1304 may include means for calculating the orientation of the antenna based on the first set of beacon signals may include calculating the orientation of the antenna by calculating a directional angle between the first reception boundary and the second reception boundary. The apparatus 1304 may include means for calculating a forward-facing direction of an object based on the orientation of the antenna and an attachment configuration of the antenna relative to the object. The apparatus 1304 may include means for changing at least one of a position, the orientation, or a direction of the antenna. The method may include receiving a second set of beacon signals after changing at least one of the position, the direction, or the orientation of the antenna. Each of the second set of beacon signals may be associated with the corresponding indication of the expected beacon location. The apparatus 1304 may include means for changing at least one of a position, the orientation, or a direction of the antenna. The method may include receiving a second set of beacon signals after changing at least one of the position, the direction, or the orientation of the antenna. Each of the second set of beacon signals may be associated with the corresponding indication of the expected beacon location. The apparatus 1304 may include means for calculating at least one of the set of interfering condition parameters, the set of spoofing condition parameters, or the set of NLOS condition parameters by generating a model of a third set of expected beacon signals based on changing at least one of the position, the direction, or the orientation of the antenna. The apparatus 1304 may include means for receiving a report of at least one of an interfering condition associated with the set of interfering condition parameters or a spoofing condition associated with the set of spoofing condition parameters. The apparatus 1304 may include means for calculating a location of at least one of a jammer source or a spoofer source based on the report. The apparatus 1304 may include means for changing at least one of a second position, a second orientation, or a second direction of the antenna based on at least one of the set of interfering condition parameters or the set of spoofing condition parameters. The apparatus 1304 may include means for communicating via a second antenna at the UE based on at least one of the set of interfering condition parameters or the set of spoofing condition parameters. The apparatus 1304 may include at least one of a ground vehicle, an aerial vehicle, an IoT device, or a wearable device. The apparatus 1304 may include means for receiving a second set of beacon signals via a second antenna at the UE. Each of the second set of beacon signals may be associated with a second corresponding indication of a second expected beacon location. The apparatus 1304 may include means for calculating a second orientation of the second antenna based on the first set of beacon signals. The apparatus 1304 may include means for calculating at least one of a set of interfering condition parameters, a set of spoofing condition parameters, or a set of NLOS condition parameters based on the first set of beacon signals and the second set of beacon signals. The apparatus 1304 may include means for calculating a location of at least one of a jammer source or a spoofer source based on at least one of the set of interfering condition parameters or the set of spoofing condition parameters. The apparatus 1304 may include means for generating a model of a third set of expected beacon signals based on changing at least one of the position, the direction, or the orientation of the antenna. The apparatus 1304 may include means for calculating at least one of the set of interfering condition parameters, the set of spoofing condition parameters, or the set of NLOS condition parameters by calculating at least one of the set of interfering condition parameters, the set of spoofing condition parameters, or the set of NLOS condition parameters further based on the model of the third set of expected beacon signals. The apparatus 1304 may include means for estimating a first reception boundary and a second reception boundary based on a cluster pattern of the first set of beacon signals. The apparatus 1304 may include means for calculating a directional angle between the first reception boundary and the second reception boundary. The apparatus 1304 may include means for calculating the orientation of the antenna by calculating the orientation of the antenna further based on the directional angle. The means may be the component 198 of the apparatus 1304 configured to perform the functions recited by the means. As described supra, the apparatus 1304 may include the Tx processor 368, the Rx processor 356, and the controller/processor 359. As such, in one configuration, the means may be the Tx processor 368, the Rx processor 356, and/or the controller/processor 359 configured to perform the functions recited by the means. It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented. The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include receiving a first set of beacon signals via an antenna at the UE. Each of the first set of beacon signals may be associated with a corresponding indication of an expected beacon location. The method may include calculating an orientation of the antenna based on the first set of beacon signals.

Aspect 2 is the method of aspect 1, where the method may include estimating a first reception boundary and a second reception boundary based on a cluster pattern of the first set of beacon signals. The method may further include calculating a directional angle between the first reception boundary and the second reception boundary. Calculating the orientation of the antenna may include calculating the orientation of the antenna further based on the calculated directional angle.

Aspect 3 is the method of any of aspects 1 and 2, where each of the first set of beacon signals may include the corresponding indication of the expected beacon location.

Aspect 4 is the method of any of aspects 1 to 3, where the method may include receiving, from a set of beacon location databases, the corresponding indication of the expected beacon location of each of a second set of beacon signals associated with a location of the UE. The first set of beacon signals may include a subset of the second set of beacon signals.

Aspect 5 is the method of aspect 4, where the method may include estimating a first reception boundary and a second reception boundary based on the first set of beacon signals and the second set of beacon signals. The method may include calculating a directional angle between the first reception boundary and the second reception boundary. Calculating the orientation of the antenna may include calculating the orientation of the antenna further based on the calculated directional angle.

Aspect 6 is the method of aspect 5, where the method may include calculating a forward-facing direction of an object based on the orientation of the antenna and an attachment configuration of the antenna relative to the object.

Aspect 7 is the method of any of aspects 1 to 6, where the method may include changing at least one of a position, the orientation, or a direction of the antenna. The method may include receiving a second set of beacon signals after changing at least one of the position, the direction, or the orientation of the antenna. Each of the second set of beacon signals may be associated with the corresponding indication of the expected beacon location. The method may include calculating at least one of a set of interfering condition parameters, a set of spoofing condition parameters, or a set of NLOS condition parameters based on the first set of beacon signals and the second set of beacon signals.

Aspect 8 is the method of aspect 7, where the method may include generating a model of a third set of expected beacon signals based on changing at least one of the position, the direction, or the orientation of the antenna. Calculating at least one of the set of interfering condition parameters, the set of spoofing condition parameters, or the set of NLOS condition parameters may include calculating at least one of the set of interfering condition parameters, the set of spoofing condition parameters, or the set of NLOS condition parameters further based on the model of the third set of expected beacon signals.

Aspect 9 is the method of any of aspects 7 and 8, where the method may include receiving a report of at least one of an interfering condition associated with the set of interfering condition parameters or a spoofing condition associated with the set of spoofing condition parameters. The method may include calculating a location of at least one of a jammer source or a spoofer source based on the report.

Aspect 10 is the method of any of aspects 7 to 9, where the method may include changing at least one of a second position, a second orientation, or a second direction of the antenna based on at least one of the set of interfering condition parameters or the set of spoofing condition parameters.

Aspect 11 is the method of any of aspects 7 to 10, where the method may include communicating via a second antenna at the UE based on at least one of the set of interfering condition parameters or the set of spoofing condition parameters.

Aspect 12 is the method of any of aspects 1 to 11, where the UE may include at least one of a ground vehicle, an aerial vehicle, an IoT device, or a wearable device.

Aspect 13 is the method of any of aspects 1 to 12, where the method may include receiving a second set of beacon signals via a second antenna at the UE. Each of the second set of beacon signals may be associated with a second corresponding indication of a second expected beacon location. The method may include calculating a second orientation of the second antenna based on the first set of beacon signals.

Aspect 14 is the method of aspect 13, where the method may include calculating at least one of a set of interfering condition parameters, a set of spoofing condition parameters, or a set of NLOS condition parameters based on the first set of beacon signals and the second set of beacon signals.

Aspect 15 is the method of aspect 14, where the method may include calculating a location of at least one of a jammer source or a spoofer source based on at least one of the set of interfering condition parameters or the set of spoofing condition parameters.

Aspect 16 is an apparatus for wireless communication, including: a memory; and at least one processor coupled to the memory and, based at least in part on information stored in the memory, the at least one processor is configured to implement any of aspects 1 to 15.

Aspect 17 is the apparatus of aspect 16, further including at least one of an antenna or a transceiver coupled to the at least one processor.

Aspect 18 is an apparatus for wireless communication including means for implementing any of aspects 1 to 15.

Aspect 19 is a computer-readable medium (e.g., a non-transitory computer-readable medium) storing computer executable code, where the code when executed by a processor causes the processor to implement any of aspects 1 to 15.

What is claimed is:

1. An apparatus for wireless communication at a user equipment (UE), comprising:
a memory; and
at least one processor coupled to the memory and, based at least in part on information stored in the memory, the at least one processor is configured to:
receive a first set of beacon signals via an antenna at the UE, wherein each of the first set of beacon signals is associated with a corresponding indication of an expected beacon location; and
calculate an orientation of the antenna based on the first set of beacon signals.

2. The apparatus of claim 1, wherein the at least one processor is further configured to:
estimate a first reception boundary and a second reception boundary based on a cluster pattern of the first set of beacon signals; and
calculate a directional angle between the first reception boundary and the second reception boundary, wherein, to calculate the orientation of the antenna, the at least one processor is configured to calculate the orientation of the antenna further based on the calculated directional angle.

3. The apparatus of claim 1, wherein each of the first set of beacon signals comprises the corresponding indication of the expected beacon location.

4. The apparatus of claim 1, wherein the at least one processor is further configured to:
receive, from a set of beacon location databases, the corresponding indication of the expected beacon location of each of a second set of beacon signals associated with a location of the UE, wherein the first set of beacon signals comprises a subset of the second set of beacon signals.

5. The apparatus of claim 4, wherein the at least one processor is further configured to:
estimate a first reception boundary and a second reception boundary based on the first set of beacon signals and the second set of beacon signals; and
calculate a directional angle between the first reception boundary and the second reception boundary, wherein, to calculate the orientation of the antenna, the at least one processor is configured to calculate the orientation of the antenna further based on the calculated directional angle.

6. The apparatus of claim 1, wherein the at least one processor is further configured to:
calculate a forward-facing direction of an object based on the orientation of the antenna and an attachment configuration of the antenna relative to the object.

7. The apparatus of claim 1, wherein the at least one processor is further configured to:
change at least one of a position, the orientation, or a direction of the antenna;
receive a second set of beacon signals after the at least one processor is configured to change at least one of the position, the direction, or the orientation of the antenna, wherein each of the second set of beacon signals is associated with the corresponding indication of the expected beacon location; and
calculate at least one of a set of interfering condition parameters, a set of spoofing condition parameters, or a set of non-line-of-sight (NLOS) condition parameters based on the first set of beacon signals and the second set of beacon signals.

8. The apparatus of claim 7, wherein the at least one processor is further configured to:
generate a model of a third set of expected beacon signals based on changing at least one of the position, the direction, or the orientation of the antenna, wherein, to calculate at least one of the set of interfering condition parameters, the set of spoofing condition parameters, or the set of NLOS condition parameters, the at least one processor is configured to calculate at least one of the set of interfering condition parameters, the set of spoofing condition parameters, or the set of NLOS condition parameters further based on the model of the third set of expected beacon signals.

9. The apparatus of claim 7, wherein the at least one processor is further configured to:
receive a report of at least one of an interfering condition associated with the set of interfering condition parameters or a spoofing condition associated with the set of spoofing condition parameters; and
calculate a location of at least one of a jammer source or a spoofer source based on the report.

10. The apparatus of claim 7, wherein the at least one processor is further configured to:
change at least one of a second position, a second orientation, or a second direction of the antenna based on at least one of the set of interfering condition parameters or the set of spoofing condition parameters.

11. The apparatus of claim 7, wherein the at least one processor is further configured to:
communicate via a second antenna at the UE based on at least one of the set of interfering condition parameters or the set of spoofing condition parameters.

12. The apparatus of claim 1, wherein the UE comprises at least one of a ground vehicle, an aerial vehicle, an Internet of Things (IoT) device, or a wearable device.

13. The apparatus of claim 1, wherein the at least one processor is further configured to:
receive a second set of beacon signals via a second antenna at the UE, wherein each of the second set of beacon signals is associated with a second corresponding indication of a second expected beacon location; and
calculate a second orientation of the second antenna based on the first set of beacon signals.

14. The apparatus of claim 13, wherein the at least one processor is further configured to:
calculate at least one of a set of interfering condition parameters, a set of spoofing condition parameters, or a set of non-line-of-sight (NLOS) condition parameters based on the first set of beacon signals and the second set of beacon signals.

15. The apparatus of claim 14, wherein the at least one processor is further configured to:
calculate a location of at least one of a jammer source or a spoofer source based on at least one of the set of interfering condition parameters or the set of spoofing condition parameters.

16. The apparatus of claim 1, further comprising a transceiver coupled to the at least one processor, wherein the transceiver is configured to receive the first set of beacon signals via the antenna at the UE.

17. A method of wireless communication at a user equipment (UE), comprising:
receiving a first set of beacon signals via an antenna at the UE, wherein each of the first set of beacon signals is associated with a corresponding indication of an expected beacon location; and
calculating an orientation of the antenna based on the first set of beacon signals.

18. The method of claim 17, further comprising:
estimating a first reception boundary and a second reception boundary based on a cluster pattern of the first set of beacon signals; and
calculating a directional angle between the first reception boundary and the second reception boundary, wherein calculating the orientation of the antenna comprises calculating the directional angle between the first reception boundary and the second reception boundary based on the calculated directional angle.

19. The method of claim 17, further comprising:
receiving, from a set of beacon location databases, the corresponding indication of the expected beacon location of each of a second set of beacon signals associated with a location of the UE, wherein the first set of beacon signals comprises a subset of the second set of beacon signals.

20. The method of claim 19, further comprising:
estimating a first reception boundary and a second reception boundary based on the first set of beacon signals and the second set of beacon signals; and
calculating a directional angle between the first reception boundary and the second reception boundary, wherein calculating the orientation of the antenna comprises calculating the orientation of the antenna further based on the calculated directional angle.

21. The method of claim 20, further comprising:
calculating a forward-facing direction of an object based on the orientation of the antenna and an attachment configuration of the antenna relative to the object.

22. The method of claim 17, further comprising:
changing at least one of a position, the orientation, or a direction of the antenna;
receiving a second set of beacon signals after changing at least one of the position, the direction, or the orientation of the antenna, wherein each of the second set of beacon signals is associated with the corresponding indication of the expected beacon location; and
calculating at least one of a set of interfering condition parameters, a set of spoofing condition parameters, or a set of non-line-of-sight (NLOS) condition parameters based on the first set of beacon signals and the second set of beacon signals.

23. The method of claim 22, further comprising:
generating a model of a third set of expected beacon signals based on changing at least one of the position, the direction, or the orientation of the antenna, wherein calculating at least one of the set of interfering condition parameters, the set of spoofing condition parameters, or the set of NLOS condition parameters comprises calculating at least one of the set of interfering condition parameters, the set of spoofing condition parameters, or the set of NLOS condition parameters further based on the model of the third set of expected beacon signals.

24. The method of claim 22, further comprising:
receiving a report of at least one of an interfering condition associated with the set of interfering condition parameters or a spoofing condition associated with the set of spoofing condition parameters; and
calculating a location of at least one of a jammer source or a spoofer source based on the report.

25. The method of claim 22, further comprising:
changing at least one of a second position, a second orientation, or a second direction of the antenna based on at least one of the set of interfering condition parameters or the set of spoofing condition parameters.

26. The method of claim 22, further comprising:
communicating via a second antenna at the UE based on at least one of the set of interfering condition parameters or the set of spoofing condition parameters.

27. The method of claim 17, further comprising:
receiving a second set of beacon signals via a second antenna at the UE, wherein each of the second set of beacon signals is associated with a second corresponding indication of a second expected beacon location; and
calculating a second orientation of the second antenna based on the first set of beacon signals.

28. The method of claim 27, further comprising:
calculating at least one of a set of interfering condition parameters, a set of spoofing condition parameters, or a set of non-line-of-sight (NLOS) condition parameters based on the first set of beacon signals and the second set of beacon signals; and
calculating a location of at least one of a jammer source or a spoofer source based on at least one of the set of interfering condition parameters or the set of spoofing condition parameters.

29. An apparatus for wireless communication at a user equipment (UE), comprising:
means for receiving a first set of beacon signals via an antenna at the UE, wherein each of the first set of beacon signals is associated with a corresponding indication of an expected beacon location; and
means for calculating an orientation of the antenna based on the first set of beacon signals.

30. A computer-readable medium storing computer executable code at a user equipment (UE), the code when executed by a processor causes the processor to:
receive a first set of beacon signals via an antenna at the UE, wherein each of the first set of beacon signals is associated with a corresponding indication of an expected beacon location; and
calculate an orientation of the antenna based on the first set of beacon signals.
